(19) United States
(12) Patent Application Publication
(10) Pub. No.: US 2011/0302003 A1
(43) Pub. Date: Dec. 8, 2011

(54) System And Method To Measure, Aggregate And Analyze Exact Effort And Time Productivity

(76) Inventors: Deodhar Swati Shirish, Pune (IN); Bhatia Madhukar Sharan, Pune (IN); Deodhar Shirish Prabhakar, Pune (IN)

(21) Appl. No.: 13/151,889

(22) Filed: Jun. 2, 2011

(30) Foreign Application Priority Data
Jun. 4, 2010 (IN) 1722/MUM/2010

(51) Int. Cl. G06Q 10/00

(52) U.S. Cl. 705/7.38

(57) ABSTRACT

A system and method for measuring exact effort spent on work related activities within an organization. The system includes at least one desktop agent cooperating with at least one server, the or each said desktop agent includes collecting means for online events including user inputs, active applications, and related application artifacts; a desktop time map unit aggregating said online events into time slots pertaining to applications and artifacts on said desktop; a user remote time map unit assessing an offline duration at said desktop; a rules and pattern matching engine; a user time analyzer mapping said online and offline time utilization to activity and purpose responsive to output of said rules and pattern matching engine; and a private time selector regulated by said user time analyzer. Server aggregates individual effort data, and adapts it into an n-dimensional effort data cube, thereby facilitating views into different aspects of organization effort.

### FIELD OF THE INVENTION

The present invention relates to the field of effort and time productivity measurement for improving work force efficiency.

Particularly, the present invention relates to the field of calculating exact effort spent on various functions and objectives of a company by tracking time spent by employees while performing their activities. Exact effort visibility enables workforce efficiency improvements by increasing the number and quality of actual work hours.

### DEFINITION OF TERMS USED IN THIS SPECIFICATION

The term ‘activity’ in this specification relates to the nature of work on which time is spent by an employee towards achieving the assigned objectives. The list of activities is determined by the organization based on its business. For instance, activity can include specific ones like planning, design, engineering, sales, marketing, or more general ones like training, meetings, conference calls, and conducting interviews.

The term ‘purpose’ in this specification relates to the specific end objectives to which the employee has been assigned. This can be the work being done on a project, for a customer, or on a function within the organization. One Purpose that is made available to all is ‘Private’ which enables an employee to allocate personal work to this category. Details of ‘Private’ time are not visible to the organization (unless the organization wants that to be visible as well).

Both ‘activity’ and ‘purpose’ can be multi-level so that more granular tracking of time is possible, which is then aggregated and rolled up as per the multi-level hierarchy.

The term ‘computing system’ in this specification relates to computing machines having Internet connectivity for instance, desktops, laptops, electronic notebooks, and personal digital assistants (PDAs).

The term ‘artifact’ in this specification relates to folders, documents, files and the like created by an employee for performing a particular task on a computing machine.

The term ‘application’ in this specification relates to preloaded desktop applications, or web based or the like programs that can be initiated on a remote server from the desktop. Preloaded applications can be for design, development, engineering, documentation, and communication using VPN, net meeting, messenger, and electronic chat application.

These definitions are in addition to those expressed in the art.

### BACKGROUND AND PRIOR ART

Exact work effort determination by an organization is crucial for establishing efficiency baseline and then making improvements. Typically, organizations require effort data to assess profitability on fixed price contracts, effort measurement for future fixed price bids, ability to bill customers for the total effort put in a particular project, verify compliance with total work hours for Time and Material (T&M) based contracts, and identify under and over-utilization of effort. Exact professional effort determination results in revenue gain, higher profitability and improved customer satisfaction.

Effort is determined at individual level, team level and then at organization level by analyzing individual time utilization. Analyzing effort in terms of time across purposes and activities ensures that employees are working for required hours and they are spending time on proper activities related to assigned projects.

Typically, manufacturing industries can easily measure productivity because the output is in terms of tangible parts or products manufactured each day or week. Further, work done by employees in the manufacturing industries is visible and measurable. However, for companies where employees work on computers to deliver products and services, it is very difficult to pin-point exact professional effort. In a typical Information Technology (IT) company, employees work through computers, and attend to meetings and calls. They can easily spend lot of time away from the PC on personal work, or on the PC for private chat, emails and browsing perhaps even without realizing it. Thus, it is difficult to estimate the real work put in by employees including nature of work (Activities) and specific end objectives (Purposes).

The Activities may include generic activities such as communication, documentation, and meetings. The Activities may also include organization specific tasks as requirements, design, implementation and testing. Further, the Purposes can include objects such as projects, product releases, features, and functions (for example, recruitment and training) and initiatives (for example, innovation and certifications). Typically, time tracking is done to check whether the employee has delivered the expected work hours while in the office. However, it is difficult to distinguish between time on actual work and for personal use. Further, activity and purpose lists can be single-level lists or multi-level hierarchical list, the latter allowing a fine-grained analysis of effort. Tracking time precisely across many activities and purposes is a major challenge.

Misaligned, inadequate and wasteful efforts result in delayed and poor quality results. Professional organizations track results by reviewing status of deliverables and tasks by using standard project management techniques where efforts are measured through approximate headcount and assuming that everyone works for standard hours each day. Further, individuals and teams may be working on multiple projects that are not easy to account for. Hence, information on exact effort and nature of the underlying efforts for achieving professional goals is either not precise or is grossly inaccurate and misleading.

Further, it is not easy for managers and organization to pro-actively improve the quality and quantity of efforts at all levels. Since time data collected manually is very subjective and inaccurate, senior level executives find it extremely difficult to get effort data of strategic value, such as effort spent on revenue generation activities versus other activities. Further, detailed recording and break up of effort in terms of projects, functions, initiatives and locations cannot be determined accurately, if done manually or using conventional systems.

The lack of visibility into exact effort is exacerbated with recent trends towards flexible working hours, teams at distributed locations, outsourcing, and work from home culture.

Yet another aspect is that while an organization benefits significantly from effort visibility it wants to respect and maintain employee privacy. Thus, it is necessary to differentiate between individual time spent on work and personal activities for ensuring privacy.

Typically, organizations depend on supervisors to interact regularly with employees for managing immediate tasks and achieving short term results. However, supervisors are constrained because of lack of any factual data about time and nature of actual work being done on computers. The supervisors rely on their judgment about people, and try to assess work output through other means. Inputs from team leads about work time are transactional, and it is not easy to scale that into trends about aggregate effort across multiple teams, projects and business units.

Effort is also estimated by calculating number of people assigned to projects, functions and tasks and the calendar time period that they have worked for. However, this calculation is inaccurate since it does not measure actual work hours per day and time spent on unrelated projects and functions, including private work. Further, it is not sufficiently detailed in terms of breakup into various activities and purposes.

Increasingly, companies require employees to fill in timesheets that includes details of time spent on various activities and purposes. However, employees tend to give inputs that match their manager's expectations, and there is no way to cross-verify the data. If timesheets become too detailed about time spent on activities and purposes, it becomes even harder for an employee to report accurate data. Typically, employees are required to fill timesheets on weekly basis. Hence, even if an employee wants to be accurate, it is impossible to accurately record the time spent on different purposes and activities.

Further, stopwatch applications are available that let employees start a timer when they begin a new task or activity, and stop the timer it when the task is completed. This enables a semi-automated timesheet, but that does not work too well because employees may forget to turn the timer on or switch the timer off. Further, there is nothing to stop employees from deliberately leaving a timer on longer to record more work time. Additionally, activities and tasks are rarely sequential and employee time is usually subject to interruptions, thus the method does not give reliable mapping to detailed activity and purposes.

Finally, there are applications that automatically track desktop and online applications being used by individuals, and classify them for tracking time. However, the applications currently available do not support automated rules-based correlation to both—activities and purposes. Further, these tools do not map and aggregate individual data as per the organization structure. Hence, they are not able to provide team and organization level analytics that help in strategic analysis and optimization of enterprise-wide effort. This prevents the ability to achieve fundamental gains in people efficiencies by understanding workload patterns and adjusting staffing for optimal business output.

Therefore there is felt a need for a system that can:
determine exact effort based on activities and purposes of interest to the organization at each level of the organization (from individual employees to teams, projects, divisions and locations);
derive the exact effort at individual level by:
   tracking time spent by employees on one or more desktops, server applications and online websites and applications;
   tracking the time spent away from the desktop in work related meetings and conference and phone calls;
   tracking non-work related time, with the option to record only total non-work time (without the details for the sake of privacy); and
   mapping individual's work time to activities and purposes.
aggregate and map individual effort into team and organization level data and statistics;
provide extensive analytics, reports and alerts related to efforts put in by employees to meet the corporate commitments;
control visibility of effort data for higher orders of hierarchy based on position in the organization and access permission; and,
provide the option to ensure that details of time spent on personal work by some or all individuals is kept separate and hidden from the organization.

### OBJECTS OF THE INVENTION

It is an object of the present invention to configure an intelligent and highly automated system to measure, record, analyze and report the total effort put in various activities and purposes within an organization by individuals and teams.

It is another object of the present invention to configure a system to enable exact effort optimization by comparing actual effort against desired effort.

It is yet another object of the present invention to determine under and over utilization of effort capacity while reducing effort that is non-productive in nature.

It is still one more object of the present invention to determine effort at individual employee level by tracking time spent by the employee on one or more desktop applications, server applications, web applications, online websites.

A related object of the present invention is to determine time spent offline (user is away from desktop), and mapping it to activities such as meetings and calls, by interfacing with the user's calendaring software, PABX server, EPABX server, Blackberry server, and location monitoring units such as swipe card systems.

It is a further object of the invention to configure a system that extends individual time mapping to more granular levels by allowing for an activity and purpose hierarchy.

Another object of the present invention is to map tracked time to activities and purposes assigned to the employee, and let the employee make annotations regarding specific achievements or issues related to time at work.

One more object of the present invention is to automatically identify various aspects of employee's time productivity including activity mix, application usage, and distribution of time across purposes, and work focus including uninterrupted work time.

Yet another object of the present invention is to provide insights into quality of effort based on activity and application mix, as well as breakup between purposes, at team and organization unit level, corresponding to different roles being played, phases of work, and kind of work, thus enabling better output by managing and maintaining the optimal activity and application mix.

An additional object of the present invention is to separate out time spent on personal activities, automatically and supported by individual override and rules, and restrict access to it based on organization policy.

One more object is to enable organizational controls on effort visibility such as allowing managers to view data only for their teams, selecting managers who are allowed to view individual effort data, and blocking access to individual data for some or all individuals.

### SUMMARY OF THE INVENTION

In accordance with the present invention, there is provided a system for exact effort and time productivity measurement, wherein professional effort put in by employees can be analyzed to effect improvements. The system comprises:
at least one desktop agent cooperating with at least one server adapted to generate exact effort data, the or each said desktop agent comprising: a) collecting means for detecting user interaction with current applications and application artifacts; b) a desktop time map unit aggregating said interactions into time slots pertaining to applications and artifacts on said desktop; c) a user remote time map unit assessing an offline duration or online interaction with a different desktop; d) a rules and pattern matching engine; e) a user time analyzer for mapping said online and offline time utilization to activity and purpose responsive to output of said rules and pattern matching engine; and f) a private time selector regulated by said user time analyzer.

Further, the server is adapted to collect the effort data from desktop agents periodically, and further configured to aggregate and roll it up as per the organization hierarchy defined at the server to provide aggregate effort data, that is then adapted into an n-dimensional effort data cube for generating effort related information selected from a group consisting of analytics, organizational trends, reports, goal compliance, alerts and rewards notifications responsive to said exact effort data. The n-dimensional effort data cube facilitates views at each level of the organization hierarchy across multiple dimensions such as purpose, activity, applications, projects, employee levels, employee roles, and locations, and wherein the data cube facilitates ability to drill down via said organization hierarchy to generate discrete effort data.

The or each said server comprises a desktop agent interface configured to collect effort data from each user; a list of valid users and organization tree mapping users to one or more organization units; access rights module to maintain and enforce access to effort data for each user and manager; activity and purpose multi-level master list comprising a subset of activities and purposes at various organizational levels; time map unit to maintain time map for each user by merging time maps sourced from one or more user desktops combined with offline time map for the user obtained from third party location and call tracking servers; an organization effort aggregation and analytics engine for retrieving said effort data from said desktop agent interface and rolling it up as per the organization hierarchy; an organization settings and rules engine for defining default rules for mapping of time to activity and purpose for individual data, which can be further modified at manager level and ultimately by each user down the organization hierarchy; collection module to communicate with one or more desktop agents of each valid user to download assigned purpose and activity list, organization default mapping rules, settings, merged time map; and a web based user interface to enable an internet browser usage for viewing organizational trends, reports, alerts, goals and administrative functions, as permitted by the user's position in the organization hierarchy and allowed access.

Typically, the collecting means on the desktop consists of a system level collector configured to run in background of user's desktop while collecting events related to user's inputs, status of current active application window, and artifacts related to the application.

Typically, said user time analyzer is adapted to let the user review and edit time utilization in relation to said activity and said purpose based on the following priority, firstly if there are user defined rules for the specific application and artifact, or manager or organization level rules obtained from the server, or default assignment to private purpose and activity.

Typically, the system on the desktop includes a user interface enabling said user to review time utilization and mapping to said activity and said purpose for current and previous days; and a server interface enabling downloading of: assigned activity and purpose; common rules; and a remote time map for said user.

Preferably, the collecting means includes an operating system collector which interfaces with the computing system's operating system.

Typically, said user remote time map unit is adapted to get third party servers input on logged in user's offline time map as sourced from at least one of swipe card and other location servers, an EPABX server, a mobile server, a Blackberry server, swipe card and other position servers.

Preferably, the server further includes a web based user interface to enable an internet browser usage for viewing organizational trends, reports, alerts, goals, and administrative functions.

According to an embodiment of the present invention, there is provided a method for exact efforts and time productivity measurement including the following steps:
tracking the user's current active application running on a desktop agent if multiple applications are opened in said desktop agent;
tracking artifacts associated with said active application to mark an online time;
marking an offline time if no activity is detected for a predetermined time in said active application;
comparing engagements, meeting requests, appointments, calls and recorded location visits of said user with duration of said offline time for tracking an accurate offline time effort;
mapping offline and online time to activities and purposes;
generating rules and pattern for enabling collective effort tracking and restricted effort data access;
enabling a private time selection that allows said user to get an approved privacy slot within a span of working hours; and
creating an n-dimensional effort data cube for generating effort related information selected from a group consisting of analytics, organizational trends, reports, goal compliance, alerts and rewards notifications responsive to said exact effort data, and wherein said effort data can be viewed for an individual or organization entity at manager level and ultimately by each user down the organization hierarchy.

Typically, the tracking artifacts include tracking files, folders, solutions and web-links used for current activity and the amount of time spent on it.

Typically, marking an offline time includes determining an inactivity time while no keyboard, keypad, touchpad and mouse movement of said desktop agent is detected, and wherein said user is not proximate to said desktop agent.

Typically, the step of comparing engagements further comprises the step of providing connectors to at least one of calendaring tools selected from a group consisting of Microsoft Outlook, Lotus Notes, Google meeting, and third party location and call tracking servers, for identifying pre-scheduled appointments like calls and meetings and subsequently mapping said pre-scheduled appointments to the activity and the purpose, whereby the connectors can include electronic file links amongst various files of the desktop agent.

Typically, the step of finding other offline activity further comprises the remote time unit which synchronizes with server to get mapping based on inputs gathered from other desktops which the user may have access to, and third party servers such as EPABX server, a mobile server, a Blackberry server, swipe card and other position servers.

Typically, the step of generating rules and pattern further comprises the steps of: tracking collective effort at multiple levels of an organization; enabling restricted access of data across peers in said organization; controlling visibility of effort data for higher orders of organizational hierarchy; and tracking effort for a plurality of industry verticals.

Typically, the method includes performing usage monitoring and analysis on captured time data by said desktop agent, wherein user's options for said purpose are determined based on said user assigned role in an organization, wherein said role is based on specific projects and functions.

Specifically, the method includes step of enabling the user to change mapping for the application and the artifact corresponding to the activity and the purpose, and further enables locking of the mapping by a project leader or administrator in the organization.

Typically, the method further comprises facilitating an employee to review and manually override specific effort data as private time data and ensuring restrictive viewing of the data, wherein employee id of the employee overriding said effort data is encrypted before transmitting the reviewed effort data marked as private time data.

Typically, the method for exact effort and time productivity measurement further includes configuring a list of valid users and organization tree including user assignment to one or more organization units; configuring an access rights module to maintain and enforce access to effort data for each user and manager; configuring an activity and purpose multi-level master list including a subset of activities and purposes at various organization levels; enabling a communication between a collection module and one or more desktop agents of each valid user for downloading assigned purpose and activity list, organization mapping rules and other settings, and merged time map; maintaining time map for each user by merging time maps sourced from one or more user desktops combined with offline time map for said user obtained from third party servers; generate organizational trends, reports for display or email to user; generating goal compliance, alerts and rewards notifications; and providing a user interface for each user to access effort data and perform administration functions as per access rights assigned.

### BRIEF DESCRIPTION OF THE DRAWINGS

Other aspects of the invention will become apparent by consideration of the accompanying drawings and their descriptions stated below, which is merely illustrative of a preferred embodiment of the invention and does not limit in any way the nature and scope of the invention in which,

FIG. 1 is a schematic of the system to measure, aggregate and analyze exact effort and time productivity of employees in accordance with the present invention; and

FIG. 2 is a flowchart of steps for the exact effort and time productivity measurement process.

### DETAILED DESCRIPTION OF THE INVENTION

The invention for measuring, aggregating and analyzing effort of employees will now be described with reference to the accompanying drawing that does not limit the scope and ambit of the invention. The description provided is purely by way of example and illustration.

Conventional effort determination systems track time spent by employees in specific activities by requiring them to manually enter the time and the corresponding activity in timesheets. However, timesheets do not give true picture of effort put in by employees because manual data is inaccurate, untimely, and highly subjective.

Further, conventional systems track time spent by individuals on desktop and web applications but the systems do not map them to organization specific activities and purposes. Moreover, conventional systems do not give an aggregated view of effort at different levels. Additionally, these systems do not address organization specific aspects as respecting individual privacy, providing data access control based on organization structure and providing controls for assessing individual data visibility.

To overcome these disadvantages, the present invention provides an intelligent and automated system that measures, aggregates and performs analysis of exact effort put in by employees. Further, the effort is mapped to activities of interest to an organization and the specific organizational purposes, and aggregated at each level of the organization hierarchy.

In accordance with one aspect of the present invention, the system is based on a client-server architecture where each one of the employee desktops is loaded with a client application which automatically tracks time utilization, maps it to activities and purposes (optionally qualified by employee annotations) relevant to the employee, and communicates the time-activity-purpose data to a server for further storage, aggregation and analysis. The server can be a dedicated workstation hosted within the organization. Alternatively, the server can be hosted on Internet by the client organization, or provisioned as part of a Software as a Service (SaaS) solution by hosting it as part of a cloud computing infrastructure.

In accordance with the present invention, the client application herein referred to as Desktop Agent is deployed on each one of the desktops and laptops of users and employees to automatically capture the time spent by them on: a) on desktop, web and mobile related applications, b) in work related meetings and calls, and c) away from the desktops that is offline or idle time to give an exact picture of the effort put in by the users and employees.

The Desktop Agent proposed by the present invention provides an interface for each employee in the organization, with the employee being assigned a set of valid purposes and activities based on the employee's presence in one or more organization teams. Every employee can view and map time utilization to activities and purposes. The employee time is assigned to defaults based on rules set by the organization. The mapping rules that are based on application used and artifact or time spent away from the PC, can be modified by each employee. An array of sourced individual effort data is sent to the server for storage, aggregation, and generation of analytical reports.

The systems and methods of present invention support extensive analytics providing team's progress estimate including exact effort mapped to activities and purposes. Thus, time productivity (average daily, weekly and monthly hours on work), application usage, online (working on computer systems) versus offline (away from desktop) time distribution, breakup of effort by activities and purposes, and related information is obtained. Further, the reports generated by the present invention give managers the basis to perform root cause analysis of delays and quality issues by assessing the activities and exact effort. Organization's executive staff (for example CxOs and VPs) can get precise insights into efforts spent on revenue earning work versus other tasks. The embodiments of invention also provide detailed breakup by projects, functions, initiatives and locations, employee levels, and roles. Further, the team's effort can always be kept in sync with desired corporate outcomes.

The present invention further provides a powerful tool that can boost overall revenue and profitability by plugging wasteful effort and reducing under-utilization of capacity. Thus, stress and burnout can be reduced by identifying teams and projects where there is sustained over-utilization of capacity. Teams that have excess capacity can be assigned more work or cost optimized by reducing the headcount. Individuals and teams can optimize their time productivity, which in turn leads to better client retention, higher quality of results, and satisfied employees.

In accordance with the present invention, the Desktop Agent generates exact effort data by automatically sourcing and mapping each employee's time utilization to assigned activity and purpose. The Desktop Agent automatically finds out an employee's current active application running on the desktop and its associated artifacts such as files, folders and web-links used for the current activity and the amount of time spent on it. If multiple applications are open, the Desktop Agent automatically tracks only the user's active window. Further, if the user is inactive, that is, there is no keyboard or mouse movement for a pre-determined time, the time thereafter is marked as ‘away from PC’ time (also referred to as ‘offline’) until the user returns to the desktop.

In some embodiments, the present invention detects offline work schedule and activities of a user by accessing the user's calendar through software as Microsoft Outlook, Google calendar, and finding out through the remote time unit at the server, the calls made as recorded by an EPABX server, a mobile server, a Blackberry server, and visits recorded by location monitors such as swipe card systems. The engagements, meeting requests, appointments, and call and location records of the user are compared with the occurrence and duration of the offline time, and wherein detected duration of the offline time is correctly updated mentioning that the user is away in meetings, calls, and in specific areas in the office. Further, the details available about the meeting, call and location are mapped to a specific activity and purpose. Thus, accurate effort tracking is performed by the present invention.

Further, the Desktop Agent of the present invention uses intelligent rules to map time spent by the employees to activities and purposes. All applications of interest to the organization are mapped to default activity and purpose. New applications being used within the organization are automatically discovered allowing more default rules to be created. Thus, reasonably accurate time utilization can be captured without even requiring the employee to manually enter or manipulate the time spent on a particular activity. Moreover, the time captured by the system can generate a detailed breakup of the applications, web links and documents referred to and the time for which they were accessed.

While the Desktop Agent provides centrally administered intelligent rules, that can be further enhanced or changed by intermediate managers, it also provides the user with the option to change the default mapping of applications and artifacts, and introduce new mappings for unmapped applications and artifacts to activities and purposes. Thus, rules for each every employee begin to match the specific work patterns for that user. Further, future instances of the applications and their artifacts are mapped automatically to the same activity and purpose for a predetermined user.

The present invention enables users to enforce mapping at folder or path level by letting the user set up default mapping of designated folders and paths to default purpose and activity. Thereafter, future instances of any file within designated folders and paths are identified by pattern matching, and mapped automatically to the corresponding default purpose and activity. The folder mapping rules can also be set by a manager or the organization. For example, if a project team follows a particular nomenclature for naming folders associated with a particular project then, all users in that project inherit the rules that map the naming folders to default purpose and activity.

The Desktop Agent envisaged by the present invention provides the employee with the details of captured time data, and its mapping to default activity and purpose. The employee can verify and edit them according to valid purposes and activities available for the employee's role. The choice available to the user for purpose allocation is automatically determined based on user's assignment to one or more projects, product releases, functions, and initiatives. The Desktop Agent gives users the provision to set or change mapping for an application and artifact to any of their allowed activity and purpose, unless the mapping is locked by the organization or the project lead. More general rules can be set based on folders where the artifacts are stored. The mapping change by the user is remembered by the Desktop Agent unless the user explicitly suggests otherwise. The Desktop Agent monitors the usage and employs team intelligence to determine the mapping. For instance, if a user is part of a team, any assignment by a team member becomes a hint or the actual assignment for a new application and artifact combination until and unless the user changes the mapping. Thus, proper mapping by one user in the team reduces time spent on activity and purpose mappings by other team members.

The organization can choose a visibility policy that protects individual privacy, and blocks details of the user's time on personal activities from being visible to the organization. Other than applications (for example, desktop applications and web applications) where organization and managers have created mappings, all other applications and browsing sessions have time spent assigned by default to private time for protecting employee's privacy. The employee must explicitly change the assignment to another activity and purpose if the time was work related. If the employee uses an application (for example, a desktop application or web application) where organization or the manager has created a rule, then employee must change that assignment to private if the employee does not want it to be identified as work. Further, user ID for time marked as private can be encrypted or encoded before being sent to the server for aggregation.

Further, when a new project is started, the mapping of application and artifacts to activity of a previous project can be taken as a reference for the new project, thus leading to an ever increasing accumulation of intelligence related to mapping. In addition to time spent on desktop related activities, the offline time is also mapped using similar intelligence and data sourced from certain desktop applications and third party corporate servers. The Desktop Agent can provide connectors to calendaring tools such as Microsoft Outlook, Lotus Notes and Google Meeting so that pre-scheduled appointments like calls and meetings can be identified and mapped to activity and purpose.

Additionally, the Desktop Agent can get information from the server about call related data sourced from mobile phone server like Blackberry and EPABX phone servers for the user's mobile, land line, and office extension that has been mapped to a default or previously set activity and purpose. Similar location specific intelligence about physical presence such as through swipe card based identification or mobile phone GPS is used to map ‘offline’ time to default or previously set activity or purpose for the specific location. Pattern and Usage Analysis is also performed for tracking offline time. Further, patterns related to assignments of Activity and Purpose for specific people, phone numbers, and locations, can be established for individuals and teams while automating future allocations.

The individual time data mapped to Activity and Purpose is rolled up and aggregated across the organization tree, thereby providing collective effort at various levels. Further, the invention includes a restricted access control module, wherein managers can view data only for their teams based on their level in the organization hierarchy. The managers cannot see peers' data or data belonging to their managers. Similarly, managers can be given specific rights regarding ability to generate custom reports and setting of mapping rules.

The present invention includes hierarchical effort control module, wherein organizations have different requirements regarding data of senior members of organization. The module restricts visibility of individual effort data for higher orders of hierarchy, for example, directors, vice presidents, principal strategy and financial managers.

In some embodiments, various effort controls are enabled allowing only select managers to view trends and blocking individual data of select senior staff.

The present invention includes industry vertical activity modules that supporting large and complex organizations, wherein multi-level activity tree is provided as various industry verticals of a large organization may have different activities and varied mapping rules. Some embodiments of the invention include a multi-level purpose tree enabling a fine-grained effort tracking at project level, module level, and individual task level. The systems and methods of the present invention also provide balancing work visibility and individual privacy, wherein the invention includes an optional private time selector for time selection that allows said user to get an approved privacy slot or a window falling within a span of working hours. Further, in offices today, employees mix personal and office work routinely, wherein the work is in flexi time modes and often work from home on their laptops. Companies have diverse views regarding the extent of work visibility that they want. Accordingly, the individual users of the system can mark time as ‘private’, and organization can decide whether private time details should be visible or not. The organization can also decide whether all managers or only selected managers are allowed to view work related details for individuals in their team, or whether trends can be made available to managers strictly at team level and up.

The captured time data and mapping to Activity and Purpose for each user is sent to the central server typically, once or twice a day via the Desktop Agent. If the central server is inaccessible the data continues to be stored locally, and is uploaded once connectivity is restored.

The invention supports multi-user and multi-desktop modes of operation. In an enterprise setup there can be several variations from a single user and single desktop theme, where multiple users may share a desktop and many users may access a remote server configuration of the central server, or a single user may work on different desktops concurrently or at different times. Data pertaining to each user is gathered and merged correctly on the central server, and then an updating is performed on the user's active desktop. This happens for all the above combinations provided that each desktop and server has the Desktop Agent installed, and as long as the user consistently logs in to the machines with one ID, typically his unique employee identification number, or a single sign-on if implemented within the organization.

In an embodiment of the invention, the central server (can also be referred to as server cooperating with a desktop agent, hereinafter in this specification) includes a database for data aggregation and analysis. The central server collects the individual effort data on a daily basis from the Desktop Agent or whenever the data gets uploaded. Further, the effort data is mapped to the organization structure to get an aggregated effort at each level of the organization. The effort data can be either viewed on a daily, weekly and monthly basis or over a selected time interval. Further, the effort data can be consolidated for any level in the organization, wherein it can be dissected along multiple dimensions including purpose, activity, applications, projects, employee levels, employee roles, divisions, and locations within a business enterprise or organization.

Further, an n-dimensional effort data cube is created on daily basis, from which self-service trends and reports can be obtained by any employee. Further, templates can be created for standard reports at an organization, manager or employee level, wherein organization templates and manager templates can be made available to some or all employees. Further, each employee can add templates of interest to a personal dashboard, which can then be viewed regularly.

In some embodiments, the central server configuration includes an alert, goals and rewards module that provides the ability to set up conditions on effort data resulting in an alert for a concerned individual or manager or both. As an option, the alert can be used to grant reward points if the effort is a positive effort. For instance, if the productive hours for a user are less than expected hours for several days, then an alert can be raised to the individual and the manager. Further, if the productive hours have been high, the employee can be granted reward points. Similarly, if the user is not delivering required effort as agreed, such as on a specific activity, or if the user is offline for more than required number of hours per day, week or month, then an alert is raised to the employee, and optionally for the manager.

In some embodiments, several alert modules can be combined into one or more goals that are set for a team, project, organization, and sub-organization. A goal compliance report can be generated indicating the number of team members who met goals and indicating any deviations from the goals. Thus, the manager need not explicitly view effort related trends and reports, or even be present in the office premises to track progress and professional commitment of staff. The goal compliance report essentially provides a comprehensive summary.

Further, activity and purpose can be a single-level list or a multi-level hierarchical or activity list. A multi-level hierarchical list is suitable for large organizations where diverse units of organization work on various activities, and wherein there is a plurality of verticals underlying the overall business activity of the organization. Further, managers at various levels can select activities that are relevant for their teams, thereby ensuring that their team members only have the relevant activities to perform mappings. Further, each employee can further short-list the activity and purpose list to the ones applicable to the employee, to further reduce the time required to select between them. A multi-level purpose hierarchy benefits from the system of the present invention, if the organization heads want to track finer levels of purpose as they move downward in the organization hierarchy. Thus, a business unit head can track effort on projects, and project managers can get effort measurement on various modules, and module leaders can get insights into effort spent on features. Further, the effort is aggregated and rolled up across the purpose and organization hierarchies.

An administration module is available in the central server that enables the definition of the organization structure, the purpose and activity hierarchy, the activities to be tracked, mapping applications and web links to default activity and purpose, defining standard alerts, and specifying standard report templates. The administration module also lets the organization set its privacy policy regarding individual data, such as whether details or at least total time spent by users on personal work should be visible, and whether access to individual time data should be blocked for selected or even all managers. In the administration module, access control rules can also be defined enabling selected managers to view individual data, create custom report templates, edit activity and purpose structure, and change activity and purpose mapping rules.

In some embodiments, the authorized managers also have access to the administration module to re-structure teams, change mappings, and create custom reports.

Further, the central server includes an online interface to users to view daily effort, long term trends and reports, alerts, goal compliance and the like data on a browser through a web client and on any desktop, laptop or handheld device. The central server also includes open interfaces to provide direct access to underlying server data.

According to this invention, open database and programmatic interface of the central server enables integration of the present invention with third party applications such as project management, invoicing, costing, Human Resources (HR) information systems, engineering software, facilities management, application license managers and the like. The effort data sourced into the third party application can result in more accurate reporting on costs, revenue, quality, people capability and resource usage in the third party applications. Further, the central server can also obtain organization and project data from these applications automatically instead of manual entry through the administration module.

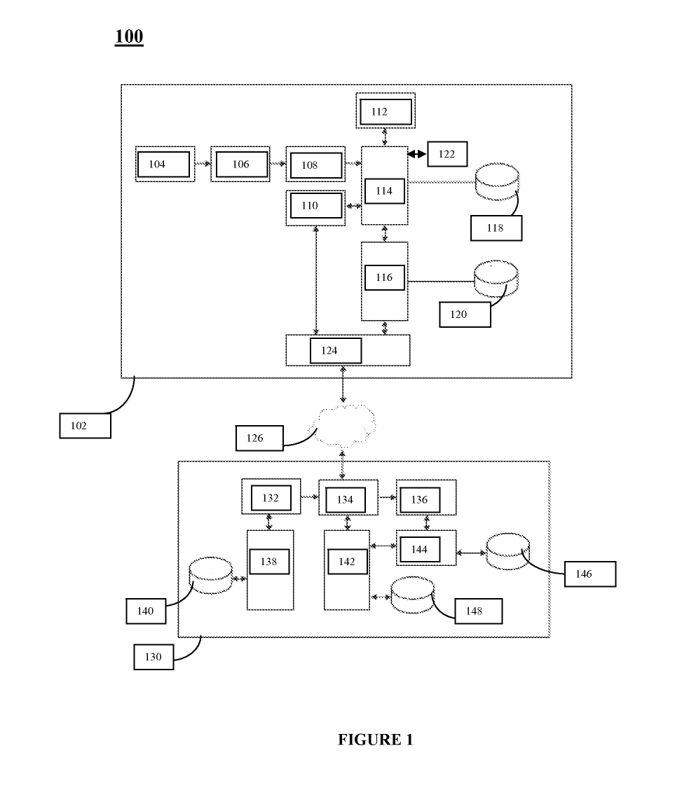

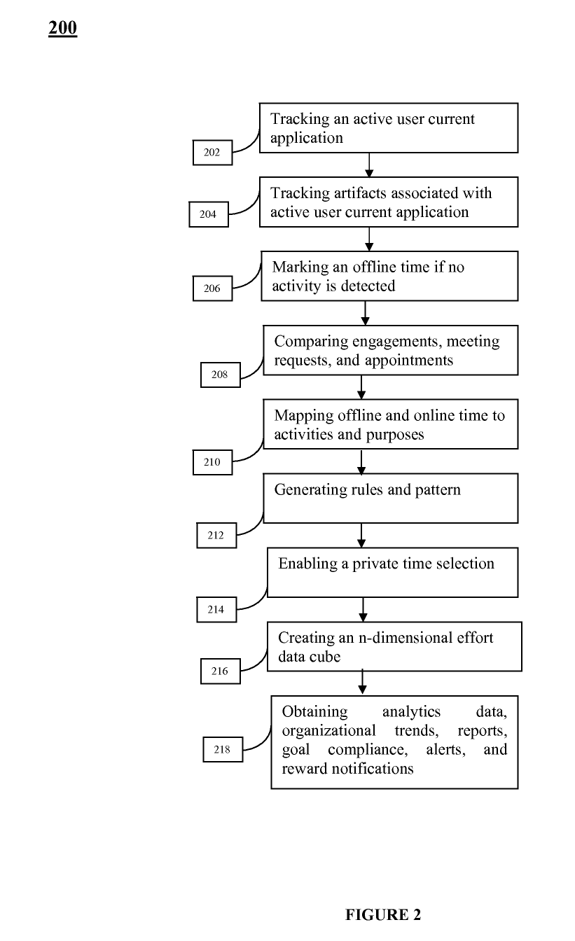

Aspects of the invention will become apparent by consideration of the accompanying drawings and their descriptions stated below, which is merely illustrative of a preferred embodiment of the invention and does not limit in any way the nature and scope of the invention in which, FIG. 1 is a schematic of the system to measure, aggregate and analyze exact effort and time productivity of employees in accordance with the present invention; and FIG. 2 is a flowchart of steps for the exact effort and time productivity measurement process in accordance with the present invention.

Referring to the accompanying drawing, FIG. 1 shows a schematic 100 of the system to measure, aggregate and analyze exact effort and time productivity. The block diagram shows two key parts of the invention namely the Desktop Agent 102 and the Server 130 and their components.

The Desktop Agent 102 comprises the following components:
OS Collector 106: The OS Collector 106 runs in the background of the user's desktop and collects events related to user inputs, status of current active application window and artifacts related to the application by interfacing with the desktop's Operating System 104 and also collects inputs from calendaring applications regarding time spent away from the desktop on meetings and the like.
Desktop Time Map Unit 108: Desktop time map unit 108 receives the collected data from the OS collector 106 and aggregates the data into time slots pertaining to the application and artifacts on the user's desktop and laptop or on another remote machine.
User Remote Time Map Unit 110: User remote time map 110 gets the server input on the logged in user's time map spent on remote desktops, laptops and servers, or as sourced from swipe card and other location servers, and EPABX, mobile, and Blackberry servers regarding the offline time that is the time spent by the user away from the computer.
User Time Analyzer 114: User time analyzer 114 merges the outputs of the Desktop Time Map unit 108 and User Remote Time Map Unit 110 and maps time utilization to Activity and Purpose (along with user annotations) based on inputs from the Rules and Pattern Matching Engine 116. The resulting Effort Map is stored in the Effort Map database 118.
Rules and Pattern Matching Engine 116: Rules and Pattern Matching Engine 116 keeps track of standard rules set by the organization, team, users and individual's usage related or preferred patterns. Using this tracked information the engine 116 guides the User Time Analyzer 114 on updating the mapping for the user's current time utilization. The rules and pattern matching engine 116 can be configured to generate rules and pattern for enabling effort tracking The Rules and Pattern Matching Engine 116 determines the rules and patterns related data for the current desktop and laptop user by accessing them from the stored user settings in the Rules and Patterns database 120.
User Interface 112: User Interface 112 lets the user review time utilization and mapping to activity and purpose for the current and previous days of the current period and enables modification, if required. For example, it also enables the user to view time utilization statistics for the past week to 30 days.
Private time selector 122: The private time selector 122 enables the user to get an approved privacy slot or window within a span of working hours, wherein the user can have some private hours. The privacy slot and its content may be required to be approved by a supervisor or team leader or project manager. The private time selector 122 is regulated by activity and purpose parameters (time utilization mapped to activity and purpose) generated by the user time analyzer 114, wherein a control is exercised on leisure activities of employees and teams.
Server Interface 124: Server Interface 124 enables upload of organization structure, common rules, and user's remote time map from the server 130. Also, the download of user effort data to the server is made through this interface. The server interface 124 enables the communication of each one of the Desktop Agents 102 with the server 130.

The Desktop Agent 102 and the Server 130 communicate over the network 126 which can be the Internet or the local area network of the organization.

The server 130 comprises the following components which help in aggregating and analyzing the sourced time data:
Desktop Agent Interface 134: Desktop Agent Interface 134 is the module with which effort data for each employee is collected and settings and rules information is uploaded to each desktop and laptop of the organization. The Desktop Agent interface 134 communicates with the Server Interface 124 to perform these tasks.
Organization Effort Aggregation and Analytics Engine 142: Organization Effort Aggregation and Analytics Engine 142 collects effort map data for each employee in the organization on daily basis from the Desktop Agent Interface 134 and stores it in an Organization Effort database 148 in a format as per the current organization structure. The Organization Effort Aggregation and Analytics Engine 142 perform the functions of effort analysis, trends, reports and generation of alerts.
Organization Settings and Rules Engine 144: Organization Settings and Rules Engine 144 keep track of the current organization structure and the rules related to mapping of time to Activity and Purpose as defined for each user, team and the like. These settings and rules are stored in the Organization rules and settings database 146 by this engine 144.
Organization Remote Time Map Unit 138: The Organization Remote Time Map

Unit 138 tracks various organization servers including swipe card and other location servers, and EPABX, mobile, and Blackberry servers, to determine the time spent on meetings, visits, phone calls (internal and external) for all employees in the company, and sends the per-user basis details to individual Desktop Agents 102 when requested to account for the offline time. This aggregate data is stored in a Remote Time Map database 140.
Remote Server Interface 132: The Remote Server Interface 132 is used by the Organization remote time Map unit 138 to source inputs from organization servers regarding location and phone calls by various users.
Web User Interface 134: Web User Interface 134 enables employees to use any Internet browser to view trends, reports, alerts, and administration functions. This interface is also available to a central administrator and managers for editing the organization structure, activity and purpose list, rules and settings.

Referring to the accompanying drawing, FIG. 2 shows a flow chart 200 depicting a method for exact efforts and time productivity measurement. A first step 202 includes tracking the current active user application even if multiple applications are opened in said desktop. A second step 204 includes tracking artifacts associated with said active user current application to mark an online time. A third step 206 includes marking an offline time if no activity is detected for a predetermined time in said active user current application. A fourth step 208 includes comparing engagements, meeting requests, appointments, calls and location visits of said user with duration of said offline time for tracking an accurate offline time effort. A fifth step 210 includes mapping time spent by said user to activities and purposes enabled by a plurality of intelligent rules. A sixth step 212 includes generating rules and pattern for enabling effort tracking; restricted effort data access; hierarchical effort control; and industry vertical effort tracking A seventh step 214 includes enabling a private time selection that allows said user to get an approved privacy slot within a span of working hours.

An eighth step 216 includes creating an n-dimensional effort data cube in which effort data is aggregated and rolled up via an organization hierarchy, and wherein aggregated and discrete effort data is available at each level of the organization hierarchy across multiple dimensions such as purpose, activity, applications, projects, employee levels, employee roles, and locations. In a ninth step 218, said user can obtain required analytics data, organizational trends related data, reports, goal compliance, alerts, and reward notifications by querying the n-dimensional effort data cube.

Therefore, according to a first aspect of the present invention, a system for exact efforts and time productivity measurement is disclosed. The system includes at least one desktop agent cooperating with at least one server, said desktop agent adapted to generate exact effort data, the or each said desktop agent including: a) collecting means for collecting online events including user inputs, active applications, and desktop artifacts; b) a desktop time map unit aggregating said online events into time slots pertaining to applications and artifacts on said desktop; c) a user remote time map unit assessing an offline duration at said desktop; d) a rules and pattern matching engine; e) a user time analyzer mapping said online and offline time utilization to activity and purpose; and f) a private time selector regulated by said user time analyzer.

The server is adapted to collect the effort data from desktop agents periodically and is further adapted to aggregate and roll it up as per the organization hierarchy defined at the server to provide aggregate effort data. The aggregate effort data is adapted into an n-dimensional effort data cube to generate effort related information selected from a group consisting of analytics, organizational trends, reports, goal compliance, alerts and rewards notifications responsive to said exact effort data. The n-dimensional effort data cube facilitates views at each level of the organization hierarchy across multiple dimensions such as purpose, activity, applications, projects, employee levels, employee roles, and locations, and wherein the data cube facilitates ability to drill down via said organization hierarchy to generate discrete effort data.

Still according to the first aspect, the or each said server comprises a desktop agent interface configured to collect effort data from each user; a list of valid users and organization tree mapping users to one or more organization units; access rights module to maintain and enforce access to effort data for each user and manager; activity and purpose multi-level master list comprising a subset of activities and purposes at various organizational levels; a time map unit to maintain time map for each user by merging time maps sourced from one or more user desktops combined with offline time map for the user obtained from third party location and call tracking servers; an organization effort aggregation and analytics engine for retrieving said effort data from said desktop agent interface; an organization settings and rules engine for getting and tracking rules related to mapping of time to activity and purpose for individual and aggregate data, rolled up via organization hierarchy and drilled down via organization hierarchy; collection module to communicate with one or more desktop agents of each valid user to download assigned purpose and activity list, organization mapping rules, settings, merged time map and a web based user interface to enable an internet browser usage for viewing trends, reports, alerts, goals and administrative functions.

According to the first aspect, said collecting means includes an operating system collector configured to run in background of user's desktop while collecting events related to user inputs, status of current active application window, and artifacts related to said application. Further, according to the first aspect, said operating system collector is interfaced with an operating system that is selected from a group consisting of a desktop operating system, a laptop operating system, a mobile phone operating system, and an electronic notebook operating system. The operating system collector can be further configured to collect inputs from calendaring applications pertaining to time spent away from said desktop, wherein the inputs from calendaring applications can be integrated with online events.

Further, said user remote time map unit is adapted to get said server input on logged in user's time map as sourced from at least one of location server such as swipe card and other location servers, an EPABX server, a mobile server, and a Blackberry server, and wherein said user's time map includes offline time spent by said user. The user time analyzer is adapted to map time utilization to activity and purpose along with any user annotation. Further, an effort map can be generated responsive to mapping time utilization to said activity and said purpose, and wherein said effort map is stored in an effort map database.

Still, according to the first aspect, the desktop agent is selected from a group consisting of a laptop, an electronic notebook, and a personal digital assistant. The system further comprises a user interface for enabling said user to review time utilization and mapping to the activity and the purpose for current and previous days; and a server interface for enabling uploading of an organization structure, common rules, and a remote time map for said user.

According to the first aspect, the private time selector is adapted to enable individual override for personal time.

According to a second aspect of the present invention, a method for exact effort and time productivity measurement is disclosed including following steps: tracking the currently active user application running on a desktop if multiple applications are opened in said desktop; tracking artifacts associated with said active user application to mark an online time; marking an offline time if no activity is detected for a predetermined time in said active user current application; comparing engagements, meeting requests, and appointments of said user with duration of said offline time for tracking an accurate offline time effort; mapping offline and online time to activities and purposes; generating rules and patterns for enabling: collective effort tracking; restricted effort data access; hierarchical effort control; and industry vertical effort tracking; enabling a private time selection that allows said user to separate out personal work from official work within a span of working hours; collecting the effort data from desktop agents every few hours at a central server, aggregating and rolling it up as per the organization hierarchy defined at the server; adapting it into an n-dimensional effort data cube for generating effort related information selected from a group consisting of analytics, organizational trends, reports, goal compliance, alerts and rewards notifications responsive to said exact effort data; and facilitating views at each level of the organization hierarchy across multiple dimensions such as purpose, activity, applications, projects, employee levels, employee roles, and locations, including the ability to drill down via said organization hierarchy to generate discrete effort data.

According to the second aspect, the step of tracking artifacts includes the step of tracking files, folders, and web-links used for current activity and the amount of time spent on it. Further, the step of marking an offline time includes the step of determining an inactivity time while no keyboard, keypad, touchpad and mouse movement of said desktop agent is detected, and wherein said user is not proximate to said desktop agent. Sill further, the step of comparing engagements further comprises the step of providing connectors to calendaring tool selected from at least one of Microsoft Outlook, Lotus Notes, and Google meeting for identifying pre-scheduled appointments like calls and meetings, as well as getting location and calls related inputs from third party servers, and subsequently mapping said pre-scheduled appointments to said activity and said purpose. Further, said desktop agent enables said user to change mapping for said application and said artifact corresponding to said activity and purpose, unless said mapping is locked.

Still according to the second aspect, the method includes configuring a list of valid users and organization tree for assigning to one or more organization units; configuring an access rights module to maintain and enforce access to effort data for each user and manager; configuring an activity and purpose multi-level master list including a subset of activities and purposes at various organization levels; enabling a communication between a collection module and one or more desktop agents of each valid user for downloading assigned purpose and activity list, organization mapping rules and other settings, and merged time map.

Further, according to the second aspect, the method includes a step of facilitating an employee to review and manually override specific effort data as private time data and assigning privacy settings to enable restrictive viewing of the data, wherein employee id of the employee overriding said effort data is encrypted before transmitting the reviewed effort data marked as private time data.

In an embodiment of the invention, a system to measure, aggregate and analyze exact effort and time productivity of employees is disclosed, the system includes a plurality of computing systems further including at least one desktop agent co-operating with at least one server having a time tracking application comprising: a rules and pattern repository adapted to store rules and patterns for effort aggregation and tracking; an effort data aggregator adapted to sense a login event and periodically capture online and offline desktop time related data and remote time related data for an employee and further adapted to aggregate the desktop time related data and remote time related data as purpose data against a predefined activity based on the rules and patterns stored in the rules and pattern repository and still further adapted to provide the compiled data as effort data; a private time selector regulated by the effort data aggregator; a user interface adapted to display the effort data to corresponding employee for review and further adapted to facilitate the employee to override specific effort data and assign privacy settings for the effort data and still further adapted to generate reviewed effort data; and a transmission unit adapted to transmit the reviewed effort data to the server using Internet technologies.

In an embodiment, the server is adapted to receive effort data of employees, wherein the effort data captures official and private time and is represented in the form of time, activity and purpose, the server further including a multilevel effort repository adapted to store the effort data and analytics for multiple levels of an organization including individual level, project level, department level and organization level; a rules repository adapted to store predefined settings and rules pertaining to visibility of the effort data and the analytics based on hierarchy and access control details of employees in an organization; an analytical engine co-operating with the effort repository and adapted to perform effort analysis and generate multilevel analytics and further adapted to store the analytics in the effort repository for a corresponding level; and a web based user interface co-operating with the effort repository and the rules repository adapted to authenticate employees and further adapted to provide an interactive interface to give access to the effort data and the analytics based on the predefined settings and the rules.

In an embodiment, a method for measuring, aggregating, and analyzing exact effort and time productivity of employees is disclosed. The method can include the following steps. A first step includes creating a rules and pattern repository for storing rules and patterns for effort aggregation and tracking A second step includes creating a multilevel effort repository for storing effort data and analytics for multiple levels of an organization including individual level, project level, department level and organization level. A third step includes creating a rules repository for storing predefined settings and rules pertaining to visibility of the effort data and the analytics based on hierarchy and access control details of employees in an organization. A fourth step includes sensing a login event at a computing system and periodically capturing online and offline desktop time related data and remote time related data for an employee. A fifth step includes aggregating the desktop time related data and remote time related data as purpose data against a predefined activity based on the rules and patterns stored in the rules and pattern repository and providing the aggregated data as effort data.

Further, a sixth step includes displaying the effort data to corresponding employee for review and facilitating the employee to override specific effort data and assign exclusive and restricted access settings for the effort data and providing a reviewed effort data. A seventh step includes enabling an optional private time selection that allows said user to obtain an approved privacy slot within a span of working hours, wherein the privacy slot can further include a leisure activities menu allowing the user or employee approved entertainment. An eighth step includes transmitting the reviewed effort data using Internet technologies. A ninth step includes receiving and analyzing the effort data and generating multilevel analytics at a remote server. A tenth step includes storing the effort data and the analytics in the effort repository. An eleventh step includes providing an interactive interface for giving authorized employees access to the effort data and the analytics based on the predefined settings and the rules.

In an embodiment, the step of capturing online and offline desktop time related data and remote time related data for an employee further includes the following steps: A first step includes tracking an active user current application running on the computing system. A second step includes tracking artifacts associated with the active user current application to collect online desktop time related data. A third step includes marking an offline time if no activity is detected for a predetermined time period in the active user current application. A fourth step includes interfacing with Blackberry, mobile servers, EPABX servers, PABX servers, calendaring applications, location server, GPS systems, attendance and entry swipe machines to collect remote time related data and its duration.

In an embodiment, the step of aggregating the desktop time related data and remote time related data as purpose data against a predefined activity includes the following steps: A first step includes mapping online desktop time related data to an activity based on rules and patterns stored in the rules and pattern repository. A second step includes merging offline desktop time related data which coincides with remote time related data based on the rules and patterns stored in the rules and pattern repository. A third step includes assignment of activity and purpose, and a fourth step includes marking non overlapping offline desktop related data as idle or private time.

In an embodiment, the step of facilitating the employee to override specific effort data includes the following steps: A first step of facilitating employee to review and manually override specific effort data as private time data and assigning privacy settings to disable viewing of the data, wherein employee id of the employee overriding the effort data is encrypted before transmitting the reviewed effort data marked as private time data. A second step of facilitating employee or user to review, override and update an existing time assignment to a new work related activity and purpose. Further, the work related updates and data overridden by the employee are visible to immediate supervisors, senior supervisors, and executive staff in the organization.

### Technical Advantages And Economic Significance

The technical advancements of the present invention include providing an intelligent and highly automated system for determining exact effort spent on various functions and objectives of a company by automatically tracking time spent by employees and teams in performing their activities.

The system envisaged by the present invention presents the exact effort put in by the employees but not restricting the tracking to desktop and online related applications but also by taking into account the time spent away from the computer by employees in work related meetings and calls. The system as disclosed in the present invention connects to calendaring and appointment tools, for example, meetings and appointments module in the Outlook Express. Further, the system retrieves the calendar of the employee to determine the scheduled conference calls, trainings, and meetings of the employee to map the offline time coinciding with the calendar to the related activity and purpose.

Additionally, the system also interfaces with the Blackberry, mobile servers, EPABX servers and PABX servers to track the time spent by employees in official calls and to track and map that time as well to activity and purpose. Interfaces are also provided to capture location and GPS and swipe machine data to detect the presence of the employees in specific office areas and to accordingly map the offline time.

Further, the system exports its effort and time productivity data by interfacing to the existing applications of an organization like project management, invoicing, costing, and Human Resources (HR) information systems, engineering software, facilities management, and application license managers while enabling them to provide richer and higher quality information. Further, the system uses intelligent rules and pattern matching techniques to automatically map the time spent by users while using applications and their associated artifacts to corresponding activities and purposes. Moreover, the individuals can change and personalize mappings based on their specific work patterns.

The system protects individual privacy by marking all unmapped applications and time as ‘private’ time, whereas onus for correctly identifying unmapped time as work is on the individual. Further, the individuals can reverse automated mappings from a configuration going from work parameters to private parameters. Further, by providing a multi-level activity hierarchy, the system caters to a large organization, wherein different units have multiple professional activities. Similarly, a multi-level purpose hierarchy enables fine-grained tracking of effort. Further, each manager can add to the purpose hierarchy short-list the activity list to fine-tune the options available for team members. Similarly, each employee can further short-list the activity and purpose list to the ones applicable to the employee, to further reduce the time required to select between them

In addition to capturing individual time utilization data and converting to effort information by mapping it to activity and purpose, the present invention stores, aggregates and performs analysis of this data across the various hierarchies of the organization. It generates customizable reports for the employees regarding their time utilization and to managers regarding the effort put in by the team members.

Thus, the present invention arms employees with knowledge about their own time utilization and also tells them about the exact time spent on projects, corporate and personal work. Further, the invention also gives a breakup by meaningful activities such as design time, documentation, browsing, chat, meetings, and calls. Additionally, using the reports generated by the present invention the users can know the time spent on specific desktop, server and web applications and on offline activities. The present invention also provides insights into work focus on how frequently the employee switches from one activity or application to another and distribution of uninterrupted work time, whereby the awareness helps employees benchmark their time utilization and use that to improve their own efficiency.

The invention performs extensive analytics and delivers results of the analytics to authorized first line managers. The first line managers get all-round visibility into their team's progress in terms of exact effort on actual activities and purposes, which may be multi-level for fine grained tracking The managers get time productivity, application usage, breakup of effort across activities and purposes, on-desktop versus offline time distribution and related information. Managers using the reports can perform root cause analysis into delays and quality issues by analyzing the trends and actual effort. Further, the senior executive staff (for example, CxOs and VPs) get precise insights into effort expended on revenue earning work versus others and detailed breakup by projects, functions, initiatives, and locations. With this information provided by the present invention, a team's effort can always be kept in sync with desired corporate outcomes. They can view teams that are overloaded and those that have excess capacity, thereby allocating work more effectively.

The present invention further provides a powerful tool that can boost overall revenue and profitability by plugging wasteful effort and reducing under-utilization of capacity, whereby stress and burnout can be reduced by identifying teams and projects where there is sustained over-utilization of capacity. Further, individuals and teams can optimize their time productivity using the analytics provided by the present invention which in turn leads to better client retention, early time to market for products, higher quality of results and satisfied employees.

While considerable emphasis has been placed herein on the components and component parts of the preferred embodiments, it will be appreciated that many embodiments can be made and that many changes can be made in the preferred embodiments without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

1. A system for exact effort and time productivity measurement, said system comprising:
at least one desktop agent cooperating with at least one server, said desktop agent adapted to generate exact effort data, the or each said desktop agent comprising: a) collecting means for collecting online events including user inputs, active applications, and application artifacts; b) a desktop time map unit aggregating said online events into time slots pertaining to applications and artifacts on said desktop; c) a user remote time map unit assessing an offline duration at said desktop; d) a rules and pattern matching engine; e) a user time analyzer for mapping said online and offline time utilization to activity and purpose responsive to output of said rules and pattern matching engine; and f) a private time selector regulated by said user time analyzer.

2. A system as claimed in claim 1, wherein the server is adapted to collect the effort data from desktop agents periodically, and the server is further adapted to aggregate and roll it up as per the organization hierarchy defined at the server to provide aggregate effort data, that is then adapted into an n-dimensional effort data cube for generating effort related information selected from a group consisting of analytics, organizational trends, reports, goal compliance, alerts and rewards notifications responsive to said exact effort data.

3. A system as claimed in claim 1, wherein the server is adapted to collect the effort data from desktop agents periodically, and aggregate and roll it up as per the organization hierarchy defined at the server to provide aggregate effort data adapted into an n-dimensional effort data cube for generating effort related information selected from a group consisting of analytics, organizational trends, reports, goal compliance, alerts and rewards notifications responsive to said exact effort data, and wherein said n-dimensional effort data cube facilitates views at each level of the organization hierarchy across multiple dimensions such as purpose, activity, applications, projects, employee levels, employee roles, and locations, and wherein said data cube facilitates ability to drill down via said organization hierarchy to generate discrete effort data.

4. A system as claimed in claim 1, wherein the or each said server comprises:
a desktop agent interface configured to collect effort data from each user;
a list of valid users and organization tree mapping users to one or more organization units;
access rights module to maintain and enforce access to effort data for each user and manager;
activity and purpose multi-level master list comprising a subset of activities and purposes at various organizational levels;
a time map unit to maintain time map for each user by merging time maps sourced from one or more user desktops combined with offline time map for the user obtained from third party location and call tracking servers;
an organization effort aggregation and analytics engine for retrieving said effort data from said desktop agent interface;
an organization settings and rules engine for getting and tracking rules related to mapping of time to activity and purpose for individual and aggregate data, rolled up via organization hierarchy and drilled down via organization hierarchy;
collection module to communicate with one or more desktop agents of each valid user to download assigned purpose and activity list, organization mapping rules, settings, merged time map; and
a web based user interface to enable an internet browser usage for viewing organizational trends, reports, alerts, goals and administrative functions.

5. A system as claimed in claim 1, wherein said collecting means includes an operating system collector adapted to run in the background of said desktop while collecting events related to user inputs, status of current active application window, and artifacts related to said application.

6. A system as claimed in claim 1, wherein said collecting means includes an operating system collector interfacing with the computing system's operating system.

7. A system as claimed in claim 1, wherein said user remote time map unit is adapted to get third party servers input on logged in user's offline time map as sourced from at least one of swipe card and other location servers, an EPABX server, a mobile server, and a Blackberry server.

8. A system as claimed in claim 1, wherein said user time analyzer is adapted to let the user review and edit time utilization in relation to said activity and said purpose.

9. A system as claimed in claim 1, wherein said desktop agent is selected from a group consisting of a laptop, an electronic notebook, and a personal digital assistant.

10. A system as claimed in claim 1, further comprising: a user interface enabling said user to review time utilization and mapping to said activity and said purpose for current and previous days; and a server interface enabling uploading of: assigned activity and purpose; common rules; and a remote time map for said user.

11. A system as claimed in claim 1, wherein the private time selector is adapted to enable individual override for personal time.

12. A method for exact effort and time productivity measurement comprising the following steps:
tracking the currently active user application running on a desktop agent if multiple applications are opened in said desktop agent;
tracking artifacts associated with said active user application to mark an online time;
marking an offline time if no activity is detected for a predetermined time in said active user current application;
comparing engagements, meeting requests, appointments, calls and visits of said user with duration of said offline time for tracking an accurate offline time effort;
mapping offline and online time to activities and purposes;
generating rules and pattern for enabling: collective effort tracking; restricted effort data access; hierarchical effort control; and industry vertical effort tracking;
enabling a private time selection that allows said user to separate out personal work from official work within a span of working hours;
collecting the effort data, and aggregating and rolling it up as per the organization hierarchy;
adapting the aggregate effort data into an n-dimensional effort data cube for generating effort related information selected from a group consisting of analytics, organizational trends, reports, goal compliance, alerts and rewards notifications responsive to said exact effort data; and
facilitating views at each level of the organization hierarchy across multiple dimensions such as purpose, activity, applications, projects, employee levels, employee roles, and locations, including the ability to drill down via said organization hierarchy to generate discrete effort data.

13. A method as claimed in claim 12, wherein the step of tracking artifacts includes the step of tracking files, folders, and web-links used for current activity and the amount of time spent on it.

14. A method as claimed in claim 12, wherein the step of marking an offline time includes the step of determining an inactivity time while no keyboard, keypad, touchpad and mouse movement of said desktop agent is detected, and wherein said user is not proximate to said desktop agent.

15. A method as claimed in claim 12, wherein the step of comparing engagements further comprises the step of providing connectors to one or more calendaring tools selected from a group consisting of Microsoft Outlook, Lotus Notes, Google meeting, and third party location and call tracking servers, for identifying pre-scheduled appointments like calls and meetings and subsequently mapping said pre-scheduled appointments to said activity and said purpose.

16. A method as claimed in claim 12 comprising step of enabling said user to change mapping for said application and said artifact corresponding to said activity and purpose, unless said mapping is locked.

17. A method as claimed in claim 12, further comprising configuring a list of valid users and organization tree for assigning to one or more organization units; configuring an access rights module to maintain and enforce access to effort data for each user and manager; configuring an activity and purpose multi-level master list including a subset of activities and purposes at various organization levels; enabling a communication between a collection module and one or more desktop agents of each valid user for downloading assigned purpose and activity list, organization mapping rules settings, and merged time map.

18. A method as claimed in claim 12, further comprising:
facilitating an employee to review and manually override specific effort data as private time data and assigning privacy settings to enable restrictive viewing of the data, wherein employee id of the employee overriding said effort data is encrypted before transmitting the reviewed effort data marked as private time data.
